(19) United States
(12) Patent Application Publication
(10) Pub. No.: US 2025/0027356 A1
(43) Pub. Date: Jan. 23, 2025

(54) ERROR DATA REPORTING FOR ENTRANCE SYSTEMS

(71) Applicant: Assa Abloy Entrance Systems AB, Landskrona (SE)

(72) Inventors: Roger DREYER, Bjarred (SE); Mathias NAVNE, Svalov (SE); Mats SAMUELSSON, Eslov (SE); Rebeca WENNERSTEN, Lund (SE); Ulf AHLFORS, Barseback (SE)

(21) Appl. No.: 18/714,938

(22) PCT Filed: Dec. 13, 2022
(86) PCT No.: PCT/EP2022/085503

§ 371 Date: May 30, 2024

(30) Foreign Application Priority Data
Dec. 14, 2021 (SE) 2130360-7

(51) Int. Cl. E05F 15/73; G06F 11/07

(52) U.S. Cl. CPC E05F 15/73; G06F 11/0736; G06F 11/0784

(57) ABSTRACT

An error data reporting arrangement (20) is disclosed which is for use in an entrance system (10) having one or more movable door members (DM1 . . . DMn) and an automatic door operator (30) for causing movement of the one or more movable door members (DM1 . . . DMn) between closed and open positions. The error data reporting arrangement 20 comprises a controller (22), a memory (24) and a communication interface (26). The controller (22) is configured for repeatedly collecting event data in the entrance system (10), and for maintaining a set of recent event data in the memory (24) while discarding older event data. The controller (22) is moreover configured for detecting an error condition in the entrance system (10), and, upon detecting the error condition, for generating an error report (27) which comprises information representing the error condition together with information representing the maintained set of recent event data. The controller (22) is furthermore configured for causing transmission (28) of the error report (27) via the communication interface (26) to a remote data receiver (29).

### TECHNICAL FIELD

The present invention generally relates to the field of entrance systems having one or more movable door members and an automatic door operator for causing movement of the one or more movable door members between closed and open positions. More specifically, the present invention relates to an error data reporting arrangement for use in such an entrance system, as well as to an associated entrance system, method, computer program product and computer readable medium.

### BACKGROUND

Entrance system having automatic door operators are frequently used for providing automatic opening and/or closing of one or more movable door members in order to facilitate entrance and exit to buildings, rooms and other areas. The door members may for instance be swing doors, sliding doors, revolving doors or overhead sectional doors.

Since entrance systems having automatic door operators are typically used in public areas, user convenience is of course important. The entrance system needs to remain long-term operational without malfunctions even during periods of heavy traffic by persons or objects passing through the entrance systems. At the same time, safety is important in order to avoid hazardous situations where a present, approaching or departing person or object (including but not limited to animals or articles brought by the person) may be hit or jammed by any of the movable door members. To this end, entrance systems are typically equipped with a sensor arrangement including one or more sensor units, each of which is connected to a controller and is arranged to monitor a respective zone at the entrance system for presence or activity of a person or object. Some of the sensor units may be designed for manual actuation, such as an elbow switch or a tag reader.

Entrance systems comprise mechanical and electrical parts, for instance in the automatic door operator, the transmission to the door members, and the sensor arrangement. Over time, these parts may be subject to wear and tear, and errors (malfunctions) can be expected to occur at some stage. There are some conflicting interests in how to handle occurring errors in entrance systems. One way is to establish regular inspections and maintenance sessions by service personnel. By scheduling the inspections frequently enough, the chances of avoiding errors may be increased. However, this comes with a considerable cost penalty. Also, far from all possible failures have a deterministic occurrence pattern, and the expected life cycle of wear parts cannot always be accurately estimated.

Another way is to rely on feedback from users or local supervisors of the entrance system, which may be invited to report in any observed peculiarity in the entrance system, such as an unusual noise, a lower than usual door member speed, an odd behavior in the automatic operation of the movable door members, or at least to report in when an actual malfunction such as a complete breakdown has occurred in the entrance system. While this approach may save some costs in the short-term perspective, it is quite likely to turn out as a bad strategy in the long run, both cost-wise and in terms of security and user satisfaction. Also, not every malfunction is identifiable by the human senses.

Therefore, there is a need to resort to more moderate maintenance and wear part replacement schemes and combine this with monitoring of the entrance system from remote. Modern IoT (Internet-of-Things) technology has made it possible to install local surveillance equipment in the entrance system and configure such equipment to continuously read and report various event data and operational data to a remote monitoring resource over the cloud. When an error occurs in the entrance system, it is useful for the site owner, manufacturer, distributor or maintenance service provider of the entrance system to analyze the various data having been reported in by the local surveillance equipment for the entrance system over time. However, the present inventors have identified draw backs with this approach. Since entrance systems may be operational for a long time before an error occurs, the continuous reporting of data by the local surveillance equipment to the remote monitoring resource will result in an enormous amount of data traffic in the cloud. In turn, there are penalties in terms of costs and resource requirements for data transmission, processing and storage. The problem is accentuated by the fact that a site owner may be responsible for a large number of entrance systems, and this applies even more to the manufacturers, distributors and maintenance service providers.

Accordingly, the present inventors have realized that there is room for improvements in this field.

### SUMMARY

An object of the present invention is therefore to provide one or more improvements in error data reporting for entrance systems having one or more movable door members and an automatic door operator for causing movements of the one or more movable door members between closed and open positions.

Accordingly, a first aspect of the present invention is an error data reporting arrangement for use in an entrance system having one or more movable door members and an automatic door operator for causing movement of the one or more movable door members between closed and open positions. The error data reporting arrangement comprises a controller, a memory and a communication interface. The controller is configured for repeatedly collecting event data in the entrance system, and maintaining a set of recent event data in the memory while discarding older event data. The controller is further configured for detecting an error condition in the entrance system. Upon detecting the error condition, the controller is configured for generating an error report which comprises information representing the error condition together with information representing the maintained set of recent event data, and then causing transmission of the error report via the communication interface to a remote data receiver. The steps of repeatedly collecting and maintaining event data will thus be an ongoing procedure in the error data reporting arrangement which is performed consistently even when the entrance system operates as intended, i.e. without errors. Then, when and only when an error condition has been detected will the error report be generated and transmitted to the remote data receiver, making use of the set of recent event data as maintained by the error data reporting arrangement.

The provision of such an error data reporting arrangement will solve or at least mitigate one or more of the problems or drawbacks identified in the above, as will be clear from the following detailed description section and the drawings.

In this document, an “error condition” is generally to be understood as any deviation from normal or expected function, behavior or performance of the entrance system or any of its components, parts or sub-systems.

Advantageously, the memory of the error data reporting arrangement comprises a buffer for accommodating a given number of events, wherein the controller of the error data reporting arrangement is configured for maintaining the set of recent event data in the memory while discarding older event data by replacing event data of an oldest event in the buffer with event data of a most recently collected event. This represents a particularly resource-efficient implementation.

In some embodiments the buffer is configured to accommodate a given number of events. The buffer may contain n storage positions, one for each event. The number n may be a predetermined number and may be any number which is suitable under the circumstances.

Additionally, or alternatively in some embodiments the buffer is configured to accommodate an adaptive number of events. The controller allocates a suitable number of storage positions in the buffer depending on the circumstances.

In some embodiments, the error data reporting arrangement is a separate device connected to a data bus of the automatic door operator in the entrance system. Hence, in such embodiments, the automatic door operator comprises a main controller and the data bus serves to interconnect the main controller with other components, parts or sub-systems of the automatic door operator. The error data reporting arrangement is configured for repeatedly collecting the event data when being communicated on the data bus between the other components, parts or sub-systems and the main controller. Conveniently, the error data reporting arrangement may be configured for detecting the error condition in the entrance system by intercepting an error code being communicated on the data bus.

In other embodiments, the error data reporting arrangement is not a separate device but is implemented by a software routine executed by the main controller.

The error data reporting arrangement may typically be used in an entrance system which further includes one or more sensor units operably connected with the main controller. Each sensor unit may be arranged to monitor a zone at the entrance system for presence or activity of a person or object. The collected event data may represent events which occur in the entrance system and pertain to one or more of the following: opening of one or more of the movable door members, closing of one or more of the movable door members, movement of one or more of the movable door members being restricted, suspended or aborted, locking or unlocking of one or more of the movable door members, and one or more of the sensor units detecting presence or activity of a person or object.

Upon detecting the error condition, the controller of the error data reporting arrangement may be further configured for retrieving operational data for the entrance system, and including the retrieved operational data in the error report. This is beneficial since it will provide additional information which may facilitate the analysis of the error condition upon receipt and processing of the error report as transmitted to the remote data receiver. Advantageously, the retrieved operational data for the entrance system may include at least one intrinsic operating parameter of the automatic door operator, representing a property or characteristic of a component, part or sub-system of the automatic door operator that can be measured, read or otherwise determined as a direct result of the operation of the automatic door operator. Additionally or alternatively, the retrieved operational data for the entrance system may include at least one extrinsic environmental parameter of the entrance system, representing a property or characteristic of the operating environment of the entrance system, not directly related to the internal operation of the automatic door operator. Non-limiting examples of intrinsic operating parameters and extrinsic environmental parameters will be given in the detailed description section.

A second aspect of the present invention is an entrance system which comprises one or more movable door members, an automatic door operator for causing movement of the one or more movable door members between closed and open positions, and an error data reporting arrangement according to the first aspect of the present invention, including any of its embodiments as disclosed in this document.

A third aspect of the present invention is a method of reporting error data for an entrance system having one or more movable door members and an automatic door operator for causing movement of the one or more movable door members between closed and open positions. The method comprises repeatedly collecting event data in the entrance system, and maintaining a set of recent event data in the memory while discarding older event data. The method further comprises detecting an error condition in the entrance system, and, upon detecting the error condition, generating an error report which comprises information representing the error condition together with information representing the maintained set of recent event data, and causing transmission of the error report to a remote data receiver.

Embodiments of the method may comprise the functionality of the error data reporting arrangement as defined for the first aspect of the present invention as referred to above, and/or the functionality of any or all of the embodiments of the error data reporting arrangement as described in this document.

A fourth aspect of the present invention is a computer program product comprising computer code for performing the method according to the third aspect when the computer program code is executed by a processing device.

A fifth aspect of the present invention is a computer readable medium having stored thereon a computer program comprising computer program code for performing the method according to the third aspect when the computer program code is executed by a processing device.

The provision of such an entrance system, method, computer program product and computer readable medium will solve or at least mitigate one or more of the problems or drawbacks identified in the above, as will be clear from the following detailed description section and the drawings.

In different embodiments, the one or more movable door members may, for instance, be swing door members, sliding door members, revolving door members, (overhead) sectional door members or pull-up door members.

In different embodiments, the remote data receiver may, for instance, be is one of a computerized central monitoring system, a computerized maintenance provider system and a computerized product development system.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings.

FIG. 1A is a schematic block diagram of an entrance system having an error data reporting arrangement generally according to the present invention.

FIG. 1B is a schematic block diagram of the error data reporting arrangement.

FIG. 2A is a schematic block diagram of an automatic door operator and the error data reporting arrangement according a first embodiment.

FIG. 2B is a schematic block diagram of an automatic door operator and the error data reporting arrangement according a second embodiment.

FIG. 3 is a schematic block diagram of a system which comprises different examples of remote data receivers and a plurality of entrance systems, each having a respective error data reporting arrangement.

FIG. 4 is a schematic top view of an entrance system according to one embodiment, in the form of a sliding door system.

FIG. 5 is a schematic top view of an entrance system according to one embodiment, in the form of a swing door system.

FIG. 6 is a schematic top view of an entrance system installation according to one embodiment, in the form of a revolving door system.

FIG. 7A is a flowchart diagram illustrating a method of reporting error data for an entrance system generally according to the present invention.

FIG. 7B is a flowchart diagram illustrating a method of reporting error data for an entrance system according to one embodiment.

FIG. 8 is a schematic illustration of a computer-readable medium in one exemplary embodiment, capable of storing a computer program product.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

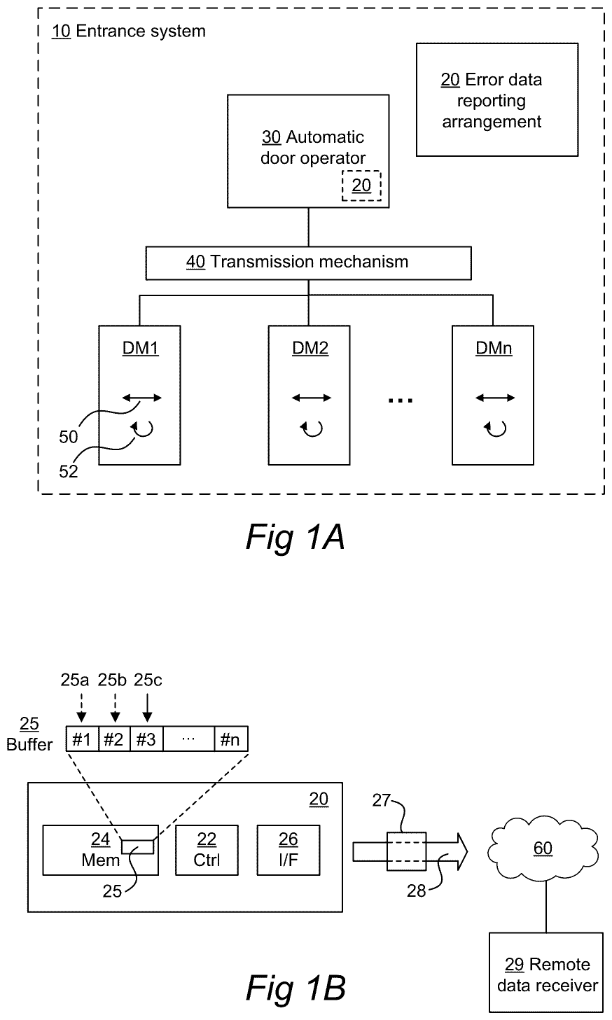

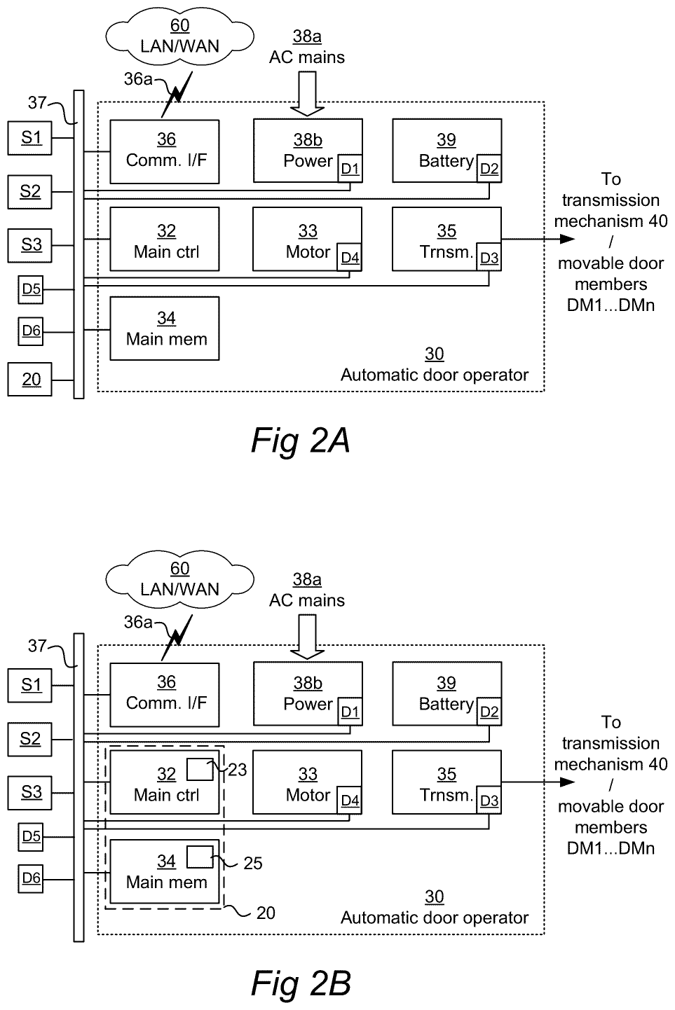

FIG. 1A is a schematic block diagram illustrating an entrance system 10 in which the inventive aspects of the present invention may be applied. The entrance system 10 comprises one or more movable door members DM1 . . . DMn, and an automatic door operator 30 for causing movement 50, 52 of the door members DM1 . . . DMn between closed and open positions. In FIG. 1A, a transmission mechanism 40 conveys mechanical power from the automatic door operator 30 to the movable door members DM1 . . . DMn. FIGS. 2A and 2B illustrate an embodiment of the automatic door operator 30 in more detail. Moreover, the entrance system 10 comprises an error data reporting arrangement 20, which is shown in more detail in FIG. 1B and which will be described further in later sections of this document.

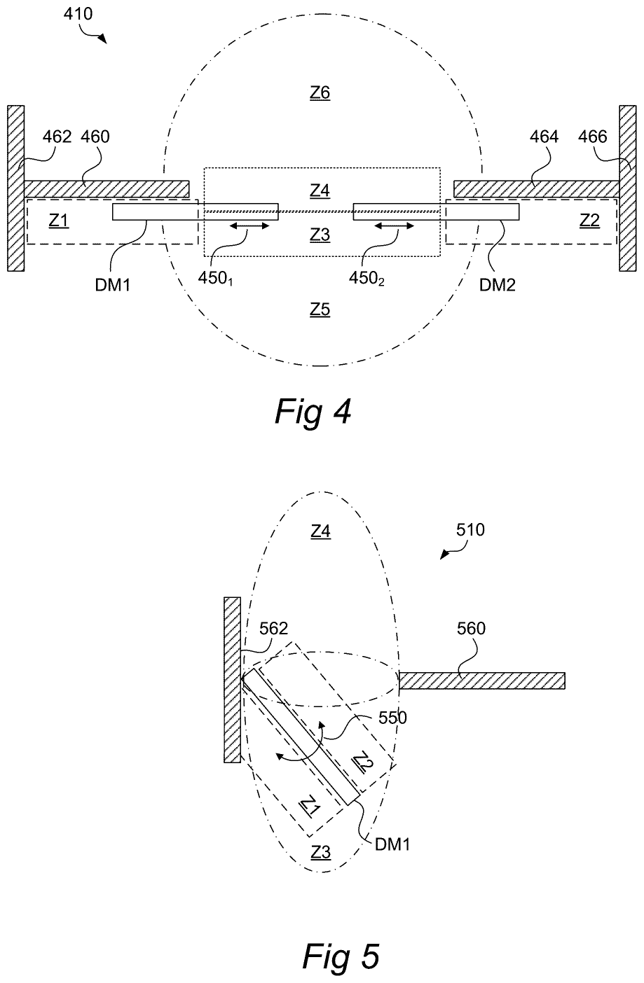

As can be seen in FIGS. 2A and 2B, the entrance system 10 comprises a main controller 32, which may be part of the automatic door operator 30 as seen in these drawings, but which may be a separate device in other embodiments. The entrance system 10 also comprises a plurality of sensor units S1-S3. Each sensor unit may generally be connected to the main controller 32 by wired connections, wireless connections, or any combination thereof. As will be exemplified in the subsequent description of the three different embodiments in FIGS. 4, 5 and 6, each sensor unit is arranged to monitor a respective zone Z1 . . . Zn at the entrance system 10 for presence or activity of a person or object. The person may be an individual who is present at the entrance system 10, is approaching it or is departing from it. The object may, for instance, be an animal or an article in the vicinity of the entrance system 10, for instance brought by the aforementioned individual. Alternatively, the object may be a vehicle or a robot. Some of the sensor units S1-S3 may be designed for manual actuation, such as an elbow switch or a tag reader.

The embodiment of the automatic door operator 30 shown in FIG. 2A will now be described in more detail. The automatic door operator 30 may typically be arranged in conjunction with a frame or other structure which supports the door members DM1 . . . DMn for movement between closed and open positions, often as a concealed overhead installation in or at the frame or support structure.

In addition to the aforementioned main controller 32, the automatic door operator 30 comprises a motor 33, typically an electrical motor, being connected to an internal transmission or gearbox 35. An output shaft of the transmission 35 rotates upon activation of the motor 33 and is connected to the external transmission mechanism 40. The external transmission mechanism 40 translates the motion of the output shaft of the transmission 35 into an opening or a closing motion of one or more of the door members DM1 . . . Dm with respect to the frame or support structure.

The automatic door operator 30 has a power unit 38b that supplies power to the electric motor 33, main controller 32 and other components of the automatic door operator 30 as appropriate. The power unit 38b typically comprises an AC/DC converter, such as a switch mode power supply (SMPS), having an input end coupled to AC mains 38a and an output end for supplying internal DC power to the electric motor 33, controller 32, etc.

In addition to the power unit 38b, the automatic door operator 30 furthermore comprises a battery 39 that may also supply power to the electric motor 33, etc., for instance in an evacuation operating mode of the automatic door operator 30, or in times of AC mains power shortage. In the disclosed embodiment, the battery 39 is coupled for charging by the power unit 38b. In other embodiments, the battery 39 may be charged by other means, such as external battery charging equipment. Preferably, therefore, the battery 39 is a rechargeable battery made from, for instance, lithium-ion (Li-ion), lithium-ion polymer (Li-ion polymer), nickel-metal hydride (NiMH), nickel-cadmium (NiCd) or lead-acid technology.

As can be seen in FIGS. 2A and 2B, the automatic door operator 30 is provided with internal detectors D1-D4 for monitoring of some of the components, parts or sub-systems of the automatic door operator 30. More specifically, in the examples of FIGS. 2A and 2B, a first detector D1 is provided for the power unit 38b, a second detector D2 is provided for the battery 39, a third detector D3 is provided for the transmission 35, and a fourth detector D4 is provided for the motor 33. The detectors D1-D4 may assist the main controller 32 in controlling the internal operation of the automatic door operator 30. As will be explained in a later section, the detectors D1-D4 may additionally serve as a source of operation data for use by the error data reporting arrangement 20.

The main controller 32 is arranged for performing different functions of the automatic door operator 30, typically in different operational modes (states) of the entrance system installation 10 and typically using inter alia sensor input data from the plurality of sensor units S1-S3 and the detectors D1-D4. Hence, the main controller 32 is operatively connected with the plurality of sensor units S1-S3. At least some of the different functions performable by the main controller 32 have the purpose of causing the desired movements 50, 52 of the door members DM1 . . . DMn. To this end, the main controller 32 has at least one control output connected to the motor 33 for controlling the actuation thereof.

The main controller 32 may be implemented in any known controller technology, including but not limited to a microcontroller, processor (e.g. PLC, CPU, DSP), FPGA, ASIC or any other suitable digital and/or analog circuitry capable of performing the intended functionality.

The main controller 32 also has an associated main memory 34. The main memory 34 may be implemented in any known memory technology, including but not limited to E (E) PROM, S (D) RAM or flash memory. In some embodiments, the main memory 34 may be integrated with or internal to the controller 32. The main memory 34 may store program instructions for execution by the controller 32, as well as temporary and permanent data used by the controller 32.

In the embodiment shown in FIGS. 2A and 2B, the entrance system 10 has a data bus 37 for data communication. Some or all of the plurality of sensor units S1-S3 are connected to the data bus 37, and so is some or all the components, parts or sub-systems of the automatic door operator 30. In the disclosed embodiments, the main controller 32, the main memory 34 and the detectors D1-D4 of the automatic door operator 30 are connected to the data bus 37. In other embodiments, the outputs of the plurality of sensor units S1 . . . Sn may be directly connected to respective data inputs of the controller 32, and the same goes for the detectors D1-D4.

The automatic door operator 30 in FIGS. 2A and 2B is enabled for external data communication 36a by means of a data communication interface 36 which is furthermore connected to the data bus 37. The external data communication 36a is typically made with another communication device or system over a data communication network 60, such as a wide area network (WAN) or local area network (LAN). Accordingly, the data communication network 60 may comply with any commercially available mobile telecommunications standard, including but not limited to GSM, UMTS, LTE, 5G, D-AMPS, CDMA2000, FOMA and TD-SCDMA. Alternatively or additionally, the data communication network 60 may comply with one or more short-range wireless data communication standards such as Bluetooth®, BLE, WiFi (e.g. IEEE 802.11, wireless LAN), Near Field Communication (NFC), RFID (Radio Frequency Identification) or Infrared Data Association (IrDA). In some embodiments, the communication may be wired, such as TCP/IP over Ethernet.

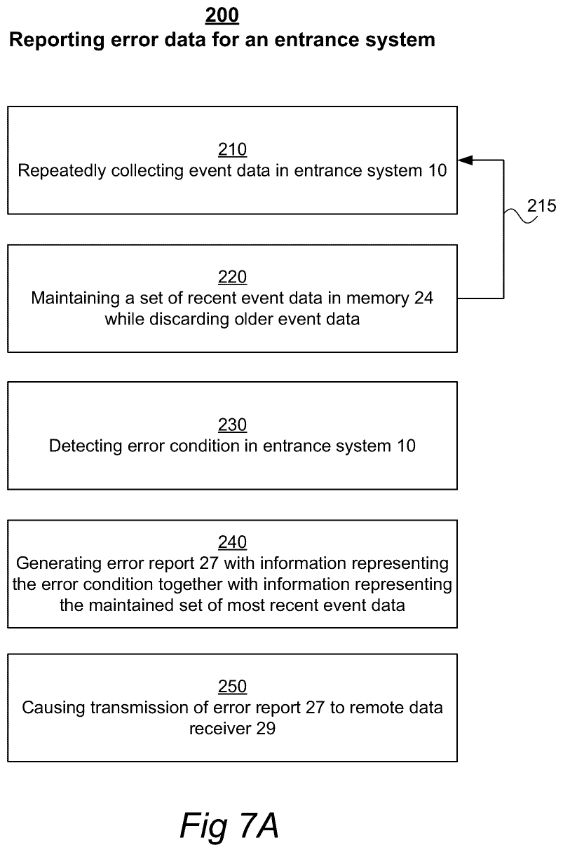

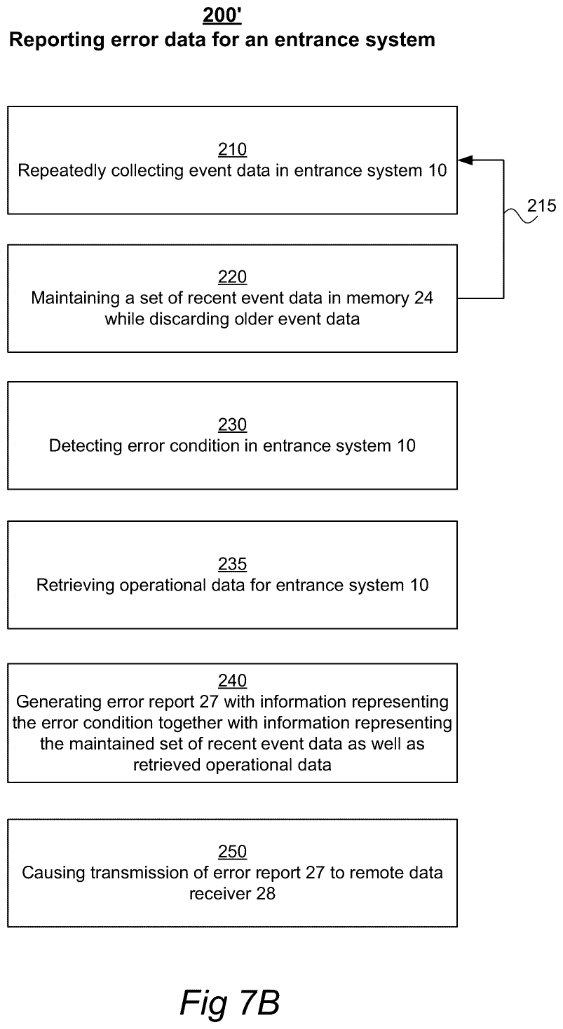

A novel and inventive way of doing error data reporting for an entrance system, such as entrance system 10, will now be described. A corresponding method 200 of reporting error data is illustrated in FIG. 7A.

As already mentioned, the entrance system 10 is provided with an error data reporting arrangement 20, which is shown in more detail in FIG. 1B. The error data reporting arrangement 20 comprises a controller 22, a memory 24 and a communication interface 26. The controller 22 is configured for repeatedly collecting event data in the entrance system 10 (cf. steps 210 and 215 in FIG. 7A) and for maintaining a set of recent event data in the memory 24 while discarding older event data (cf. step 220 in FIG. 7A).

The controller 22 is moreover configured for detecting an error condition in the entrance system 10 (cf. step 230 in FIG. 7A). Upon detecting the error condition, the controller 22 is configured for generating an error report 27 which comprises information representing the error condition together with information representing the maintained set of recent event data (cf. step 240 in FIG. 7A), and causing transmission 28 of the error report 27 via the communication interface 26 to a remote data receiver 29 (cf. step 250 in FIG. 7A). The controller 22, memory 24 and communication interface 26 may, generally, be implemented in any of the ways referred to above for the main controller 32, main memory 34 and data communication interface 36 of the automatic door operator 30, without limitation.

As will be understood from the above and as indicated at 215 in FIG. 7A, the steps of repeatedly collecting 210 and maintaining 220 event data will be an ongoing procedure in the error data reporting arrangement 20: the procedure will be performed consistently even when the entrance system 10 operates as intended (i.e., without errors). Then, when—and only when—an error condition has been detected at 230 will the error report 27 be generated 240 and transmitted 250 (cf. 28 in FIG. 1B) to the remote data receiver 29, making use of the set of recent event data as maintained by the error data reporting arrangement 20 in the memory 24.

In the disclosed embodiment of FIG. 1B, the memory 24 comprises a buffer 25 for accommodating a given number n of events. Accordingly, the buffer 25 may contain n storage positions, one for each event. The number n may be a predetermined number and may be any number which is suitable under the circumstances, ranging for instance between 5 and 100 (such as n=5, 10, 20, 30, 50 or 100), without limitation. Additionally or alternatively, n may be an adaptive number such that the controller 22 allocates a suitable number n of storage positions in the buffer 25 depending on the circumstances. The number n may be both predetermined and adaptive in the sense that n can, at any time, have a certain given value, which in turn can be adapted over time.

When the controller 22 has collected event data for a most recent event in step 210, the controller 22 is configured to replace the event data of an oldest event in the buffer 25 with the event data of the most recently collected event.

To keep track of the oldest event in the buffer 25, all event data stored therein may be time stamped. Alternatively, a pointer may be used to point at the storage position in the cyclic buffer 25 that currently stores the event data of the oldest event. In this case, the buffer 25 may thus be a cyclic buffer. Such a pointer is illustrated at 25a, 25b and 25c in FIG. 1B. Storage position 25a is where the event data of the oldest event is currently stored in the buffer 25, whereas storage positions 25b and 25c are where the event data of the second and third oldest events, respectively, are currently stored in the buffer 25.

In the embodiment shown in FIG. 2A, the error data reporting arrangement 20 is a separate device connected to the data bus 37 of the automatic door operator 30. It is recalled that the data bus 37 is for interconnecting the main controller 32 with other components, parts or sub-systems of the automatic door operator 30. Being a separate device connected to the data bus 37, the error data reporting arrangement 20 is configured for repeatedly collecting the event data when being communicated on the data bus 37 between said other components, parts or sub-systems and the main controller 32. To this end, the error data reporting arrangement 20 may conveniently be configured for detecting the error condition in the entrance system 10 by intercepting an error code being communicated on the data bus 37.

In the embodiment shown in FIG. 2B, the error data reporting arrangement 20 is instead implemented by a software routine executed by the main controller 32 of the automatic door operator 30. In this embodiment, therefore, the controller 22 of the error data reporting arrangement 20 is implemented by the main controller 32 of the automatic door operator 30, whereas the memory 24 of the error data reporting arrangement 20 is implemented by the main memory 34 of the automatic door operator 30.

It is recalled that the entrance system 10 further includes one or more sensor units S1-S3 operably connected with the main controller 32 of the automatic door operator 30. Assisted by the sensor units S1-D3 and the internal detector D1-D4 as appropriate, the event data collected by the error data reporting arrangement 20 may, for instance, represent any of the following events occurring in the entrance system 10:
opening of one or more of the movable door members (DM1 . . . DMn),
closing of one or more of the movable door members (DM1 . . . DMn),
movement of one or more of the movable door members (DM1 . . . DMn) being restricted,
movement of one or more of the movable door members (DM1 . . . DMn) being suspended,
movement of one or more of the movable door members (DM1 . . . DMn) being aborted,
locking of one or more of the movable door members (DM1 . . . DMn),
unlocking of one or more of the movable door members (DM1 . . . DMn), and
one or more of the sensor units detecting presence or activity of a person or object.

In an advantageous embodiment, the controller 22 (32) of the error data reporting arrangement 20 is further configured, upon detecting the error condition, for retrieving operational data for the entrance system 10, and for including the retrieved operational data in the error report 27. This can be seen at steps 235 and 240 in the method 200′ represented by the flowchart in FIG. 7B.

The retrieved operational data for the entrance system 10 may include at least one intrinsic operating parameter of the automatic door operator 30, representing a property or characteristic of a component, part or sub-system of the automatic door operator 30 that can be measured, read or otherwise determined (for instance by the aforementioned detectors D1-D4) as a direct result of the operation of the automatic door operator 30. Examples of such components, parts or sub-system of the automatic door operator 30 are the motor 33, the transmission 35, the sensor units S1-S3, the power supply 38b and the battery 39. Examples of intrinsic operating parameter are opening energy (the electric energy consumed in order to perform an opening movement of the one or more door members DM1 . . . DMn), closing energy (the electric energy consumed in order to perform a closing movement of the one or more door members DM1 . . . DMn, reopening energy, battery inner resistance, battery no load voltage, battery capacity, motor inner resistance and (internal) temperature.

Additionally or alternatively, the retrieved operational data may include at least one extrinsic environmental parameter of the entrance system, representing a property or characteristic of the operating environment of the entrance system 10, not directly related to the internal operation of the automatic door operator 30. The extrinsic environmental parameters may be obtained by external detectors D5 and D6 (see FIGS. 2A and 2B), being connected to the data bus 37 and therefore being accessible to the controller 22 of the error data reporting arrangement 20 or the main controller 32 of the automatic door operator 30. The extrinsic environmental parameters may be representative of the contextual environment, i.e. the conditions, of the entrance system 10 in which the automatic door operator 30 operates. Examples of such conditions represented by the extrinsic environmental parameter are (external) temperature, humidity, air pressure, wind load, time of day, weekday, season, operating mode of the automatic door operator, sensor activation sequence (e.g. the order in which the sensor units S1-S3 are triggered), and activation pattern of the movable door members DM1 . . . DMn (e.g. how frequently they are actuated, or how long it was since the last actuation).

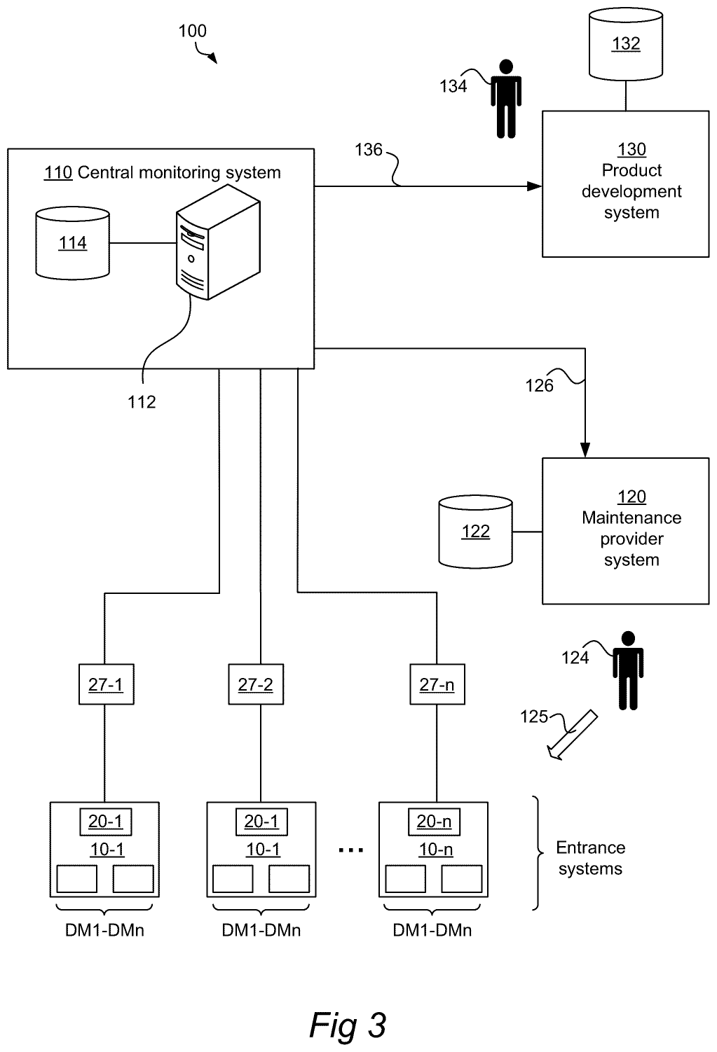

As can be seen at 100 in FIG. 3, a central monitoring system 110 is provided for monitoring a plurality of entrance systems 10-1-10-n. Each individual entrance system has one or more movable door members DM1 . . . DMn, an automatic door operator (30, not seen in FIG. 3) for causing movement of the one or more movable door members DM1 . . . DMn between closed and open positions, and a respective error data reporting arrangement 20-1-20-n being configured as described in preceding sections of this document. Each individual entrance system 10-1-10-n is configured for providing a respective error report 27-1-27-n to the central monitoring system 110. The error reports 27-1-27-n may be communicated over a data communication network using a data communication interface (i.e., interface 26 or data communication interface 36 in FIGS. 1A, 2A and 2B).

A purpose of the central monitoring system 110 may be to detect failures among the monitored entrance systems 10-1-10-n and to initiate appropriate action when applicable. To this end, the central monitoring system 110 comprises computerized central monitoring functionality 112 and a database 114. The computerized central monitoring functionality 112 may, for instance, be implemented by a server computer, a cluster of server computers or by cloud-based resources such as Amazon AWS, Microsoft Azure or Google Cloud. The database 114 may, for instance, be implemented as a DBaaS (Database-as-a-service). Some exemplary database technologies include MySQL, PostgreSQL, Oracle RDBMS, Amazon DynamoDB, MongoDB, Hadoop, Apache Cassandra, Amazon Aurora, EnterpriseDB, Oracle Database Cloud Service or Google Cloud.

Upon detection of a failure for a particular entrance system 10-1-10-n according to the error reports 27-1-27-n, the computerized central monitoring functionality 112 is configured for generating an alert signal 126:136 and for submitting the alert signal 126:136 to at least one external entity 120:130, such as a computerized maintenance provider system 120 or computerized product development system 130.

The alert signal 126 sent to the computerized maintenance provider system 120 will enable a maintenance provider to send 125 service personnel 124 to the individual entrance system 10-1-10-n for which the failure has been identified, in order to perform an action of inspection, maintenance, upgrade or spare part replacement at the individual entrance system.

The computerized product development system 130 receiving the alert signal 136 from the central monitoring system 110 will enable product developers 134 to stay informed of entrance system components or functionalities for which a failure has been detected and proactively make changes in the design of such components or functionalities, or of related components or functionalities (for instance belonging to the same family of components, or being based on a same product platform). The change may be propagated to a product design database 132.

Accordingly, the remote data receiver 29 to which the error data reporting arrangement 20 of the present invention sends its error report 27 may, for instance, be the computerized central monitoring system 110, or alternatively the computerized maintenance provider system 120 or the computerized product development system 130.

Three different exemplifying embodiments of entrance systems 10:10-1-10-n will now be described with reference to FIGS. 4, 5 and 6.

Turning first to FIG. 4, a first embodiment of an entrance system in the form of a sliding door system 410 is shown in a schematic top view. The sliding door system 410 comprises first and second sliding doors or wings DM1 and DM2, being supported for sliding movements 4501 and 4502 in parallel with first and second wall portions 460 and 464. The first and second wall portions 460 and 464 are spaced apart: in between them there is formed an opening which the sliding doors DM1 and DM2 either blocks (when the sliding doors are in closed positions), or makes accessible for passage (when the sliding doors are in open positions). An automatic door operator (not seen in FIG. 4 but referred to as 30 in FIGS. 1 and 2) causes the sliding movements 4501 and 4502 of the sliding doors DM1 and DM2.

The sliding door system 410 comprises a plurality of sensor units, each monitoring a respective zone Z1-Z6. The sensor units themselves are not shown in FIG. 4, but they are generally mounted at or near ceiling level and/or at positions which allow them to monitor their respective zones Z1-Z6. To facilitate the reading, each sensor unit will be referred to as Sx in the following, where x is the same number as in the zone Zx it monitors (Sx being selected from {S1 . . . S6}, Zx being selected from {Z1-Z6}.

A first sensor unit S1 is mounted at a lateral positon to the far left in FIG. 4 to monitor zone Z1. The first sensor unit S1 is a side presence sensor, and the purpose is to detect when a person or object occupies a space between the outer lateral edge of the sliding door DM1 and an inner surface of a wall or other structure 462 when the sliding door DM1 is moved towards the left in FIG. 4 during an opening state of the sliding door system 410. The provision of the side presence sensor S1 will help avoiding a risk that the person or object will be hit by the outer lateral edge of the sliding door DM1, and/or jammed between the outer lateral edge of the sliding door DM1 and the inner surface of the wall 462, by triggering abort and preferably reversal of the ongoing opening movement of the sliding door DM1.

A second sensor unit S2 is mounted at a lateral positon to the far right in FIG. 4 to monitor zone Z2. The second sensor unit S2 is a side presence sensor, just like the first sensor unit S1, and has the corresponding purpose—i.e. to detect when a person or object occupies a space between the outer lateral edge of the sliding door DM2 and an inner surface of a wall 466 when the sliding door DM2 is moved towards the right in FIG. 4 during the opening state of the sliding door system 410.

A third sensor unit S3 is mounted at a first central positon in FIG. 4 to monitor zone Z3. The third sensor unit S3 is a door presence sensor, and the purpose is to detect when a person or object occupies a space between or near the inner lateral edges of the sliding doors DM1 and DM2 when the sliding doors DM1 are moved towards each other in FIG. 4 during a closing state of the sliding door system 410. The provision of the door presence sensor S3 will help avoiding a risk that the person or object will be hit by the inner lateral edge of the sliding door DM1 or DM2, and/or be jammed between the inner lateral edges of the sliding doors DM1 and DM2, by aborting and preferably reversing the ongoing closing movements of the sliding doors DM1 and DM2.

A fourth sensor unit S4 is mounted at a second central positon in FIG. 4 to monitor zone Z4. The fourth sensor unit S4 is a door presence sensor, just like the third sensor unit S3, and has the corresponding purpose—i.e. to detect when a person or object occupies a space between or near the inner lateral edges of the sliding doors DM1 and DM2 when they are moved towards each other in FIG. 4 during a closing state of the sliding door system 410.

The side presence sensors S1 and S2 and door presence sensors S3 and S4 may be image-based sensor units, active IR (infrared) sensor unit, etc.

A fifth sensor unit S5 is mounted at an inner central positon in FIG. 4 to monitor zone Z5. The fifth sensor unit S5 is an inner activity sensor, and the purpose is to detect when a person or object approaches the sliding door system 410 from the inside of the premises. The provision of the inner activity sensor S5 will trigger the sliding door system 410, when being in a closed state or a closing state, to automatically switch to an opening state for opening the sliding doors DM1 and DM2, and then make another switch to an open state when the sliding doors DM1 and DM2 have reached their fully open positions.

A sixth sensor unit S6 is mounted at an outer central positon in FIG. 4 to monitor zone Z6. The sixth sensor unit S6 is an outer activity sensor, and the purpose is to detect when a person or object approaches the sliding door system 410 from the outside of the premises. Similar to the inner activity sensor S5, the provision of the outer activity sensor S6 will trigger the sliding door system 410, when being in its closed state or its closing state, to automatically switch to the opening state for opening the sliding doors DM1 and DM2, and then make another switch to an open state when the sliding doors DM1 and DM2 have reached their fully open positions.

The inner activity sensor S5 and the outer activity sensor S6 may, for instance, be radar (microwave) sensor units or image-based sensor units.

A second embodiment of an entrance system installation in the form of a swing door system 510 is shown in a schematic top view in FIG. 5. The swing door system 510 comprises a single swing door DM1 being located between a lateral edge of a first wall 560 and an inner surface of a second wall 562 which is perpendicular to the first wall 560. The swing door DM1 is supported for pivotal movement 550 around pivot points on or near the inner surface of the second wall 562. The first and second walls 560 and 562 are spaced apart: in between them an opening is formed which the swing door DM1 either blocks (when the swing door is in closed position), or makes accessible for passage (when the swing door is in open position). An automatic door operator (not seen in FIG. 5 but referred to as 30 in FIGS. 1 and 2) causes the movement 550 of the swing door DM1.

The swing door system 510 comprises a plurality of sensor units, each monitoring a respective zone Z1-Z4. The sensor units themselves are not shown in FIG. 5, but they are generally mounted at or near ceiling level and/or at positions which allow them to monitor their respective zones Z1-Z4. Again, each sensor unit will be referred to as Sx in the following, where x is the same number as in the zone Zx it monitors (Sx being selected from {S1 . . . S4}, Zx being selected from {Z1-Z4}.

A first sensor unit S1 is mounted at a first central positon in FIG. 5 to monitor zone Z1. The first sensor unit S1 is a door presence sensor, and the purpose is to detect when a person or object occupies a space near a first side of the (door leaf of the) swing door DM1 when the swing door DM1 is being moved towards the open position during an opening state of the swing door system 510. The provision of the door presence sensor S1 will help avoiding a risk that the person or object will be hit by the first side of the swing door DM1 and/or be jammed between the first side of the swing door DM1 and the second wall 562: a sensor detection in this situation will trigger abort and preferably reversal of the ongoing opening movement of the swing door DM1.

A second sensor unit S2 is mounted at a second central positon in FIG. 5 to monitor zone Z2. The second sensor unit S2 is a door presence sensor, just like the first sensor S1, and has the corresponding purpose—i.e. to detect when a person or object occupies a space near a second side of the swing door DM1 (the opposite side of the door leaf of the swing door DM1) when the swing door DM1 is being moved towards the closed position during a closing state of the swing door system 510. Hence, the provision of the door presence sensor S2 will help avoiding a risk that the person or object will be hit by the second side of the swing door DM1 and/or be jammed between the second side of the swing door DM1 and the first wall 560; a sensor detection in this situation will trigger abort and preferably reversal of the ongoing closing movement of the swing door DM1.

The door presence sensors S1 and S2 may be image-based sensor units, active IR (infrared) sensor units, etc.

A third sensor unit S3 is mounted at an inner central positon in FIG. 5 to monitor zone Z3. The third sensor unit S3 is an inner activity sensor, and the purpose is to detect when a person or object approaches the swing door system 510 from the inside of the premises. The provision of the inner activity sensor S3 will trigger the sliding door system 510, when being in a closed state or a closing state, to automatically switch to an opening state for opening the swing door DM1, and then make another switch to an open state when the swing door DM1 has reached its fully open position.

A fourth sensor unit S4 is mounted at an outer central positon in FIG. 5 to monitor zone Z4. The fourth sensor unit S4 is an outer activity sensor, and the purpose is to detect when a person or object approaches the swing door system 510 from the outside of the premises. Similar to the inner activity sensor S3, the provision of the outer activity sensor S4 will trigger the swing door system 510, when being in its closed state or its closing state, to automatically switch to the opening state for opening the swing door DM1, and then make another switch to an open state when the swing door DM1 has reached its fully open position.

The inner activity sensor S3 and the outer activity sensor S4 may, for instance, be radar (microwave) sensor units or image-based sensor units.

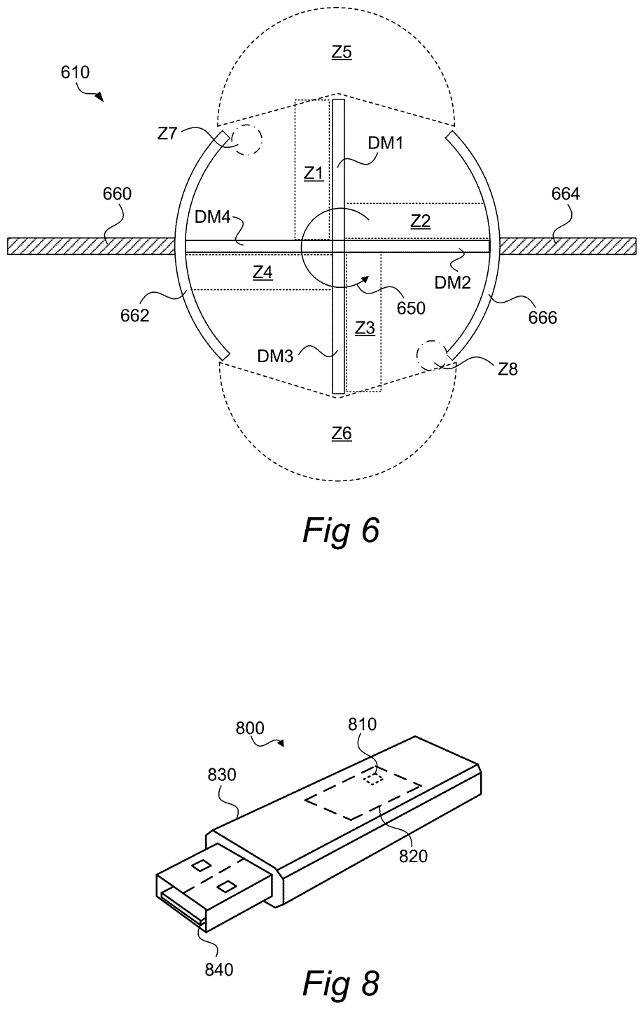

A third embodiment of an entrance system installation in the form of a revolving door system 610 is shown in a schematic top view in FIG. 6. The revolving door system 610 comprises a plurality of revolving doors or wings DM1-DM4 being located in a cross configuration in an essentially cylindrical space between first and second curved wall portions 662 and 666 which, in turn, are spaced apart and located between third and fourth wall portions 660 and 664. The revolving doors DM1-DM4 are supported for rotational movement 650 in the cylindrical space between the first and second curved wall portions 662 and 666. During the rotation of the revolving doors DM1-DM4, they will alternatingly prevent and allow passage through the cylindrical space. An automatic door operator (not seen in FIG. 6 but referred to as 30 in FIGS. 1 and 2) causes the rotational movement 650 of the revolving doors DM1-DM4.

The revolving door system 610 comprises a plurality of sensor units, each monitoring a respective zone Z1-Z8. The sensor units themselves are not shown in FIG. 6, but they are generally mounted at or near ceiling level and/or at positions which allow them to monitor their respective zones Z1-Z8. Again, each sensor unit will be referred to as Sx in the following, where x is the same number as in the zone Zx it monitors (Sx being selected from {S1 . . . S8}, Zx being selected from {Z1-Z8}.

First to fourth sensor units S1-S4 are mounted at respective first to fourth central positons in FIG. 6 to monitor zones Z1-Z4. The first to fourth sensor units S1-S4 are door presence sensors, and the purpose is to detect when a person or object occupies a respective space (sub-zone of Z1-Z4) near one side of the (door leaf of the) respective revolving door DM1-DM4 as it is being rotationally moved during a rotation state or start rotation state of the revolving door system 610. The provision of the door presence sensors S1-S4 will help avoiding a risk that the person or object will be hit by the approaching side of the respective revolving door DM1-DM4 and/or be jammed between the approaching side of the respective revolving door DM1-DM4 and end portions of the first or second curved wall portions 662 and 666. When any of the door presence sensors S1-S4 detects such a situation, it will trigger abort and possibly reversal of the ongoing rotational movement 650 of the revolving doors DM1-DM4.

The door presence sensors S1-S4 may, for instance, be image-based sensor units or active IR (infrared) sensor units.

A fifth sensor unit S5 is mounted at an inner non-central positon in FIG. 6 to monitor zone Z5. The fifth sensor unit S5 is an inner activity sensor, and the purpose is to detect when a person or object approaches the revolving door system 610 from the inside of the premises. The provision of the inner activity sensor S5 will trigger the revolving door system 610, when being in a no rotation state or an end rotation state, to automatically switch to a start rotation state to begin rotating the revolving doors DM1-DM4, and then make another switch to a rotation state when the revolving doors DM1-DM4 have reached full rotational speed.

A sixth sensor unit S6 is mounted at an outer non-central positon in FIG. 6 to monitor zone Z6. The sixth sensor unit S6 is an outer activity sensor, and the purpose is to detect when a person or object approaches the revolving door system 610 from the outside of the premises. Similar to the inner activity sensor S5, the provision of the outer activity sensor S6 will trigger the revolving door system 610, when being in its no rotation state or end rotation state, to automatically switch to the start rotation state to begin rotating the revolving doors DM1-DM4, and then make another switch to the rotation state when the revolving doors DM1-DM4 have reached full rotational speed.

The inner activity sensor S5 and the outer activity sensor S6 may, for instance, be radar (microwave) sensors units or image-based sensor units.

Seventh and eighth sensor units S7 and S8 are mounted near the ends of the first or second curved wall portions 662 and 666 to monitor zones Z7 and Z8. The seventh and eighth sensor units S7 and S8 are vertical presence sensors. The provision of these sensor units S7 and S8 will help avoiding a risk that the person or object will be jammed between the approaching side of the respective revolving door DM1-DM4 and an end portion of the first or second curved wall portions 662 and 666 during the start rotation state and the rotation state of the revolving door system 610. When any of the vertical presence sensors S7-S8 detects such a situation, it will trigger abort and possibly reversal of the ongoing rotational movement 650 of the revolving doors DM1-DM4.

The vertical presence sensors S7-S8 may, for instance, be image-based sensor units or active IR (infrared) sensor units.

FIG. 8 is a schematic illustration of a computer-readable medium 800 in one exemplary embodiment, capable of storing a computer program product 810. The computer-readable medium 800 in the disclosed embodiment is a memory stick, such as a Universal Serial Bus (USB) stick: the computer-readable medium 800 may however be embodied in various other ways instead, as is well known per se to the skilled person. The USB stick 800 comprises a housing 830 having an interface, such as a connector 840, and a memory chip 820. In the disclosed embodiment, the memory chip 820 is a flash memory, i.e. a non-volatile data storage that can be electrically erased and re-programmed.

The memory chip 820 stores the computer program product 810 which is programmed with computer program code (instructions) that when loaded into and executed by a processing device, such as a CPU, will perform the method 200 of predicting failures among a plurality of entrance system installations, as described above with reference to FIG. 7, in any or all of its disclosed embodiments. The USB stick 800 is arranged to be connected to and read by a reading device for loading the instructions into the processing device. The processing device may, for instance, be comprised in the computerized failure prediction functionality 112 in FIG. 3.

It should be noted that a computer-readable medium can also be other mediums such as compact discs, digital video discs, hard drives or other memory technologies commonly used. The computer program code (instructions) can also be downloaded from the computer-readable medium via a wireless interface to be loaded into the processing device.

The invention has been described above in detail with reference to embodiments thereof. However, as is readily understood by those skilled in the art, other embodiments are equally possible within the scope of the present invention, as defined by the appended claims.

1. An error data reporting arrangement (20) for use in an entrance system (10) having one or more movable door members (DM1 . . . DMn) and an automatic door operator (30) for causing movement of the one or more movable door members (DM1 . . . DMn) between closed and open positions, the error data reporting arrangement (20) comprising:
a controller (22);
a memory (24); and
a communication interface (26), wherein the controller (22) is configured for:
repeatedly collecting event data in the entrance system (10);
maintaining a set of recent event data in the memory (24) while discarding older event data;
detecting an error condition in the entrance system (10); and
upon detecting the error condition:
generating an error report (27) which comprises information representing the error condition together with information representing the maintained set of recent event data; and
causing transmission (28) of the error report (27) via the communication interface (26) to a remote data receiver (29).

2. The error data reporting arrangement (20) as defined in claim 1,
wherein the memory (24) comprises a buffer (25) for accommodating a given number of events, and
wherein the controller (22) is configured for maintaining the set of recent event data in the memory (24) while discarding older event data by replacing event data of an oldest event in the buffer (25) with event data of a most recently collected event.

3. The error data reporting arrangement (20) as defined in claim 2, wherein the buffer (25) is configured to accommodate a given number (n) of events.

4. The error data reporting arrangement (20) as defined in claim 2, wherein the buffer is configured to accommodate an adaptive number of events.

5. The error data reporting arrangement (20) as defined in claim 1, wherein the automatic door operator (30) comprises a main controller (32) and a data bus (37) for interconnecting the main controller (32) with other components, parts or sub-systems of the automatic door operator (30), wherein the error data reporting arrangement (20) is a separate device connected to the data bus (37) and configured for repeatedly collecting said event data when being communicated on the data bus between said other components, parts or sub-systems and the main controller (32).

6. The error data reporting arrangement (20) as defined in claim 5, wherein the error data reporting arrangement (20) is configured detecting the error condition in the entrance system (10) by intercepting an error code being communicated on the data bus (37).

7. The error data reporting arrangement (20) as defined in claim 1, wherein the automatic door operator (30) comprises a main controller (32) and a data bus (37) for interconnecting the main controller (32) with other components, parts or sub-systems of the automatic door operator (30), wherein the error data reporting arrangement (20) is implemented by a software routine executed by the main controller (32).

8. The error data reporting arrangement (20) as defined in claim 5, the entrance system further including one or more sensor units (S1 . . . Sn) operably connected with the main controller (32), each sensor unit being arranged to monitor a zone (Z1 . . . Zn) at the entrance system (10) for presence or activity of a person or object, wherein the collected event data represents events occurring in the entrance system (10), the events pertaining to one or more of the following:
opening of one or more of the movable door members (DM1 . . . DMn);
closing of one or more of the movable door members (DM1 . . . DMn);
movement of one or more of the movable door members (DM1 . . . DMn) being restricted;
movement of one or more of the movable door members (DM1 . . . DMn) being suspended;
movement of one or more of the movable door members (DM1 . . . DMn) being aborted;
locking of one or more of the movable door members (DM1 . . . DMn);
unlocking of one or more of the movable door members (DM1 . . . DMn); and
one or more of the sensor units detecting presence or activity of a person or object.

9. The error data reporting arrangement (20) as defined in claim 1, wherein the controller (22) is further configured for:
upon detecting the error condition, retrieving operational data for the entrance system (10); and
including the retrieved operational data in the error report (27).

10. The error data reporting arrangement (20) as defined in claim 9, wherein the retrieved operational data for the entrance system includes at least one intrinsic operating parameter of the automatic door operator (30), representing a property or characteristic of a component, part or sub-system of the automatic door operator that can be measured, read or otherwise determined as a direct result of the operation of the automatic door operator (30).

11. The error data reporting arrangement (20) as defined in claim 9, wherein the retrieved operational data for the entrance system includes at least one extrinsic environmental parameter of the entrance system, representing a property or characteristic of the operating environment of the entrance system, not directly related to the internal operation of the automatic door operator.

12. An entrance system (10) comprising:
one or more movable door members (DM1 . . . DMn);
an automatic door operator (30) for causing movement of the one or more movable door members (DM1 . . . Dm) between closed and open positions; and
an error data reporting arrangement (20) as defined in claim 1.

13. A method (200) of reporting error data for an entrance system (10) having one or more movable door members (DM1 . . . DMn) and an automatic door operator (30) for causing movement of the one or more movable door members (DM1 . . . Dm) between closed and open positions, the method (700) comprising:
repeatedly collecting (210, 215) event data in the entrance system (10);
maintaining (220) a set of recent event data in a memory (24) while discarding older event data;
detecting (230) an error condition in the entrance system (10); and
upon detecting the error condition:
generating (240) an error report (27) which comprises information representing the error condition together with information representing the maintained set of recent event data; and
causing transmission (250) of the error report (27) to a remote data receiver (29).

14. The method as defined in claim 13, further comprising providing
a controller; and
a communication interface,
wherein the controller is configured for:
repeatedly collecting the event data in the entrance system;
maintaining the set of recent event data in the memory while discarding older event data;
detecting the error condition in the entrance system; and
upon detecting the error condition:
generating the error report which comprises information representing the error condition together with information representing the maintained set of recent event data; and
causing transmission of the error report via the communication interface to the remote data receiver.

15. The method as defined in claim 13, wherein the remote data receiver (28) is one of:
a computerized central monitoring system (110);
a computerized maintenance provider system (120); and
a computerized product development system (130).

16. A computer program product comprising computer code for performing the method according to claim 13 when the computer program code is executed by a processing device.

17. A computer readable medium having stored thereon a computer program comprising computer program code for performing the method according to claim 13 when the computer program code is executed by a processing device.
